(19) United States
(12) Patent Application Publication
(10) Pub. No.: US 2004/0098735 A1
(43) Pub. Date: May 20, 2004

(54) Disk loading apparatus for a disk drive

(75) Inventors: Hyoung-Jun Kim, Daegu City (KR); Sung-Hun Kim, Seoul City (KR); Bok-Hyun Pack, Suwon City (KR)

Correspondence Address: FLESHNER & KIM, LLP, P.O. BOX 221200, CHANTILLY, VA, 20153, US

(73) Assignee: LG Electronics Inc.

(21) Appl. No.: 10/700,678

(22) Filed: Nov. 5, 2003

(30) Foreign Application Priority Data
Nov. 14, 2002 (KR) 2002-70928
Aug. 2, 2003 (KR) 2003-53651

(51) Int. Cl. G11B 17/03; G11B 17/04

(52) U.S. Cl. 720/612

(57) ABSTRACT

A disk loading apparatus is provided for a disk drive. The disk loading apparatus includes a tray rotated with respect to a main base to perform disk loading and unloading operations. The tray is provided with a center of rotation at one side of the main body. A driving motor for driving the tray is provided on one side of the main base, and power from the driving motor is transmitted through a power transmission unit to rack gear formed on a bottom surface of the tray. The rack gear is in the form of an arc with a predetermined radius of curvature. With a disk loading apparatus so constructed, the size of the tray can be minimized and the disk drive as a whole can be miniaturized.

### BACKGROUND OF THE INVENTION

1. Field of the Invention

The invention relates to a disk drive, and more particularly, to a disk loading apparatus for loading and unloading a disk into and out of the disk drive.

2. Background of the Related Art

FIG. 1 is a plan view of a related art disk drive, while FIG. 2 is a plan view showing a state in which a tray and a clamp are provided in a main base of the disk drive shown in FIG. 1.

Referring to FIGS. 1 and 2, a main base 1 forms a frame structure of the disk drive. The main base 1 has a generally rectangular hole in a center thereof, and a pickup base 3 installed in the hole. The pickup base 3 is supported on the main base 1 at a rear end thereof by vibration-proof members 5. Each of the vibration-proof members 5 is made of, for example, an elastic material and functions to cause the pickup base 3 to be supported on the main base 1 and to prevent noise and vibration from being transferred therebetween.

A spindle motor 7 for rotating a disk is installed on the pickup base 3. A turntable 8 on which the disk is seated is provided at a top end of the spindle motor 7 and is rotated by the spindle motor 7. A pickup 9 is installed on the pickup base 3 to be guided along guide shafts 10. The pickup 9 records signals onto the disk or reads recorded signals from the disk, for example, by irradiating a signal-recording surface of the disk with light. The pickup 9 is driven by a sled motor (not shown) to move along the guide shafts 10.

Further, a front end of the pickup base 3 is supported on a lift base 12. Vibration-proof members 5′ are securely interposed between the lift base 12 and the pickup base 3 to cause the pickup base 3 to be supported on the lift base 12 and prevent noise and vibration from being transferred therebetween.

The lift base 12 is provided with rotary shafts 13 at both sides of a rear end thereof. Each of the rotary shafts 13 is inserted into the main base 1 and functions as a pivot center about which a front end of the lift base 12 is lifted or lowered. An interlocking protrusion 15 is formed at the front end of the lift base 12 and guided along a lift cam 28 of a lift guide 25 to be described below.

Further, a loading motor 17 for providing a driving force for loading and unloading the disk is installed at a front portion of the main base 1. The driving force from the loading motor 17 is transmitted to a driving pulley 18 by a belt 19. A geared portion formed on the driving pulley 18 is engaged with that of a driving gear 20. A rack-driving geared portion 22 is also formed on the driving gear 20 and engaged with a rack gear 33 provided on a bottom surface of a tray 30, shown in FIG. 3, on which the disk is seated for the loading and unloading operation.

In addition, another geared portion (not shown) of the driving gear 20 is engaged with a driven rack 27 of the lift guide 25. The lift guide 25 functions to lift and lower the end of the pickup base 3 at the end of the disk loading operation and at the beginning of the disk unloading operation, respectively, so that the turntable 8 and the tray do not interfere with each other during the disk loading or unloading operation.

The lift cam 28 is formed on the lift guide 25. The interlocking protrusion 15 is inserted into and guided by the lift cam 28. A driving protrusion 27′ is formed at one side of the lift guide 25. When the tray is positioned at a specific location at the end of the disk loading operation, the driving protrusion 27′ interlocks with a guide recess formed on the bottom surface of the tray 30 so that the driven rack 27 of the lift guide 25 is engaged with the driving gear 20 to transmit the driving force.

Reference numeral 29 designates an emergency lever which is configured to allow the lift guide 25 to be manually operated in an emergency so that the tray can be taken out. Reference numeral 32 designates a disk-seating surface formed on a top surface of the tray 30. Reference numeral 35 designates a clamping bracket. Reference number 36 designates a clamp configured to fix the disk to the turntable 8.

In the related art disk drive so constructed, the driving force from the loading motor 17 is transmitted to the tray 30 through engagement between the geared portion 22 of the driving gear 20 and the rack gear 33 of the tray 30 so that the tray 30 slides into and out of the main base 1 in a fore and aft direction.

That is, as viewed in the plan view of FIG. 3, the rectangular tray 30 protrudes toward the front of the main base 1 so that the disk can be exchanged. After the disk has been exchanged, the tray 30 enters the main base 1, as shown in FIG. 2.

However, there are the following problems in the related art described above.

First, since the tray 30 slides into and out of the main base 1, there is a problem in that the length of the tray 30 becomes large. That is, since a portion for allowing the tray 30 to be supported on the main base 1 is required when the tray 30 protrudes completely out of the front of the main base 1, the longitudinal length of the tray 30 becomes relatively large. Consequently, there is a problem in that the overall size of the disk drive is relatively large. Further, the rack gear 33 should be formed to extend from the front of the tray 30 to the rear thereof. Therefore, there is another problem in that a period of time required for moving tray 30 for exchange of disks is relatively large.

### SUMMARY OF THE INVENTION

An object of the invention is to substantially solve at least one or more of the above problems and/or disadvantages in a whole or in part and to provide at least the advantages described hereinafter.

In order to achieve at least the above objects, in whole or in part, and in accordance with the purposes of the invention, as embodied and broadly described, there is provided a disk loading apparatus for a disk drive according to an embodiment of the invention comprising a main body, and a tray including a disk-seating portion configured to be rotated inside and outside the main body about a center of rotation located on one side of the main body.

To further achieve at least the above objects, in whole or in part, and in accordance with the purposes of the invention, as embodied and broadly described, there is provided a disk loading apparatus for a disk drive according to an embodiment of the invention comprising a main body a tray rotatably coupled to a shaft formed on a corner of the main body so that the tray is horizontally rotatable about the shaft in a plane parallel to a top surface of the main body.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a plan view of a related art disk drive;

FIG. 2 is a plan view showing a state in which a tray is seated within the disk drive of FIG. 1;

FIG. 3 is a plan view showing a state in which a tray protrudes out from the disk drive of FIG. 1;

FIG. 4 is a schematic plan view of a disk drive having a disk loading apparatus according to an embodiment of the invention;

FIG. 5 is a schematic plan view of a power transmission unit for the disk loading apparatus of FIG. 4;

FIG. 6 is a schematic front view of the disk drive of FIG. 4;

FIG. 7 is a schematic exploded sectional view of the disk loading apparatus of FIG. 4;

FIG. 8 is a schematic plan view of a rotary shaft of the disk loading apparatus of FIG. 4;

FIG. 9 is a schematic view of a disk loading apparatus of FIG. 1 showing a state in which a portion of the tray protrudes out from a main body of the disk drive;

FIG. 10 is a schematic plan view of a disk drive having a disk loading apparatus according to an embodiment of the invention;

FIG. 11 is a schematic plan view of a power transmission unit for the disk loading apparatus of FIG. 10;

FIGS. 12A to 12E are schematic views sequentially illustrating unloading operations in accordance with an embodiment of the invention;

FIGS. 13A to 13E are schematic views sequentially illustrating loading operations in accordance with an embodiment of the invention;

FIG. 14 is a schematic plan view of a disk drive having a disk loading apparatus according to another embodiment of the invention; and

FIGS. 15A to 15H are schematic views sequentially illustrating loading and unloading operations in the embodiment of FIG. 14.

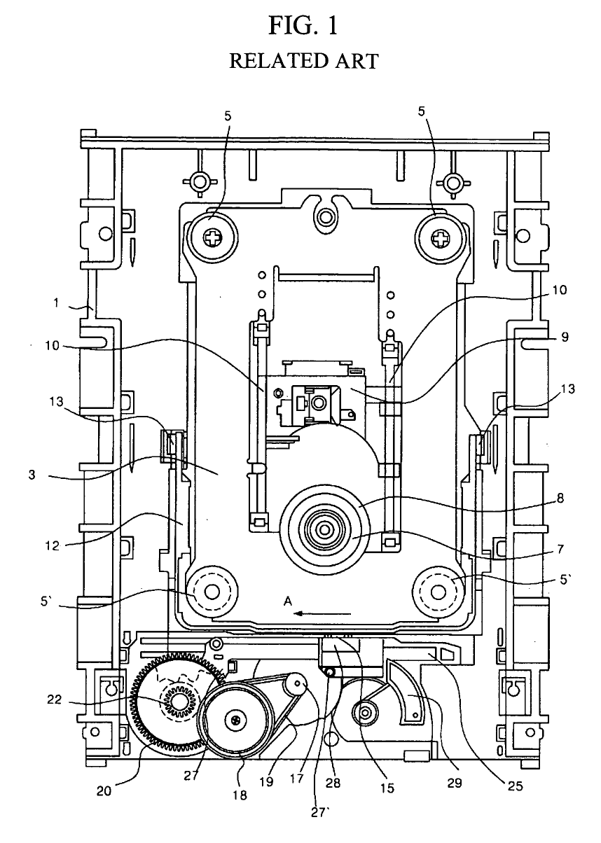

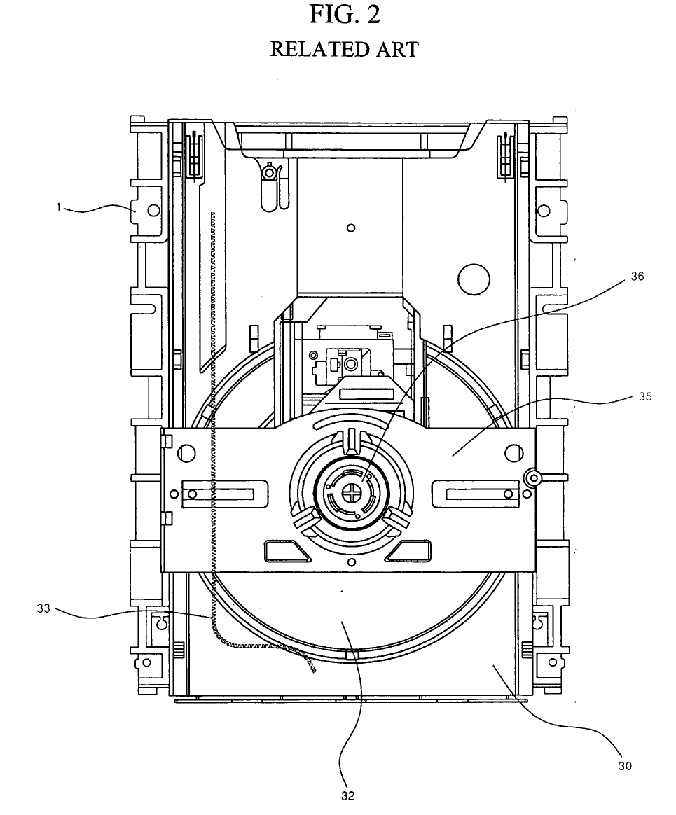

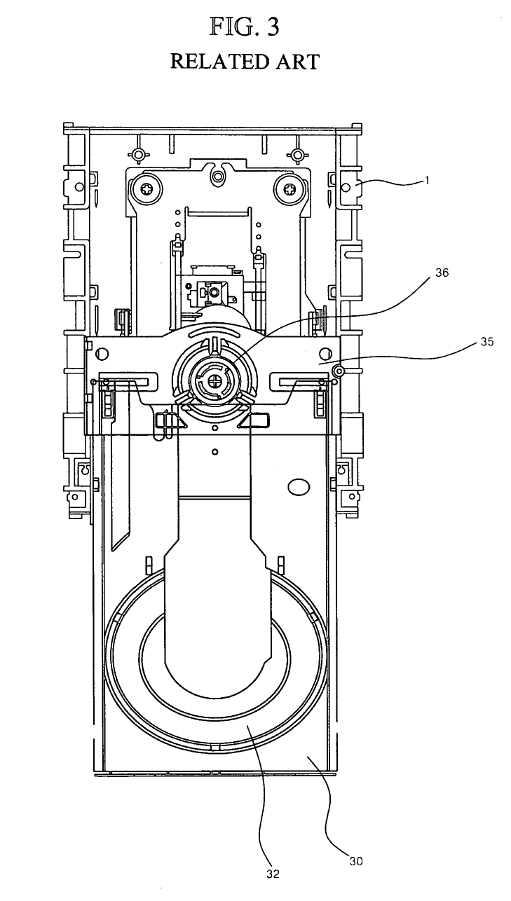

### DETAILED DESCRIPTION OF PREFERRED EMBODIMENTS

Hereinafter, a disk loading apparatus for a disk drive according to embodiments of the invention will be described in detail with reference to the accompanying drawings, in which like reference numerals have been used to indicate like elements.

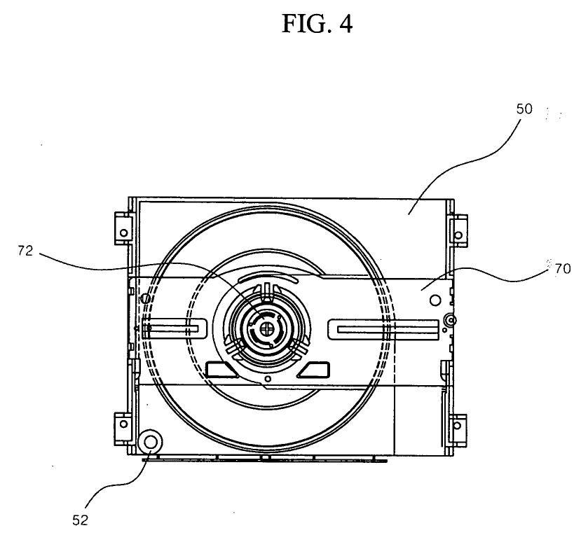

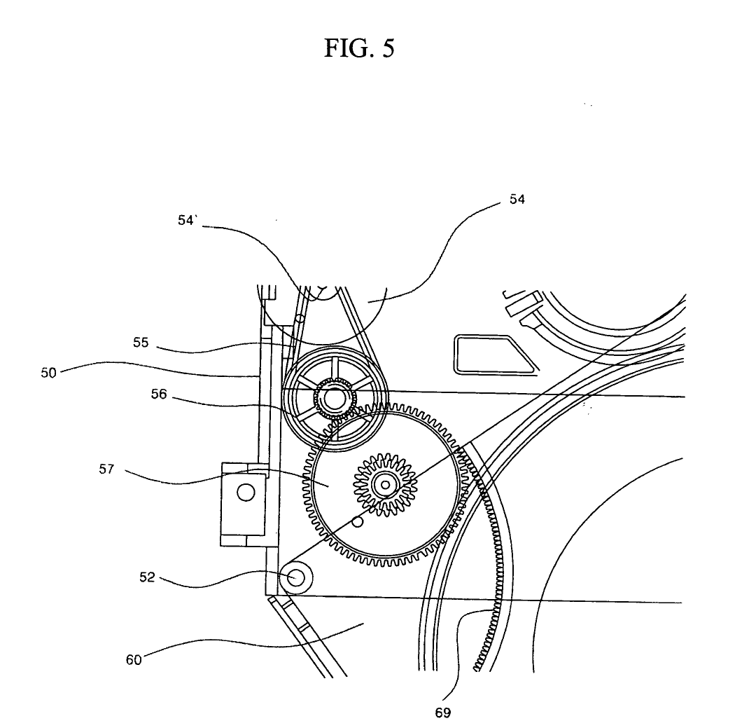

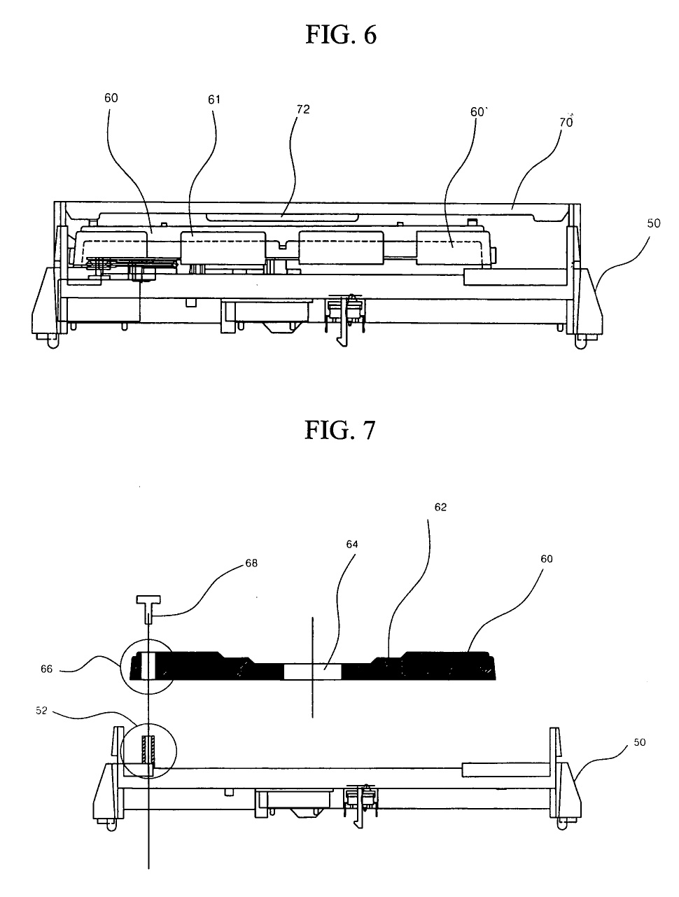

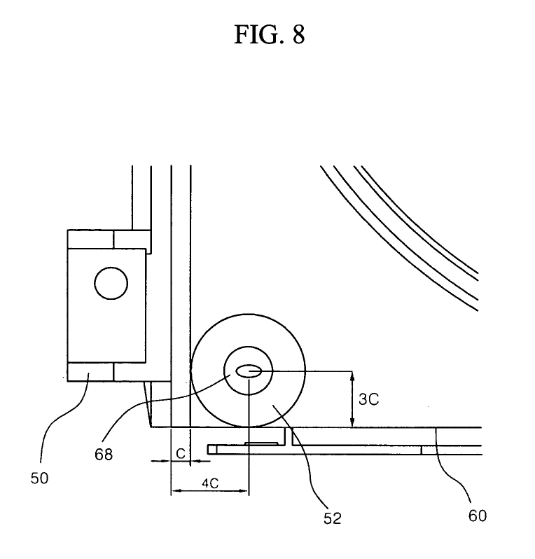

FIG. 4 is a schematic plan view of a disk drive having a disk loading apparatus according to an embodiment of the invention. FIG. 5 is a schematic plan view of a portion of the disk loading apparatus of FIG. 4. FIG. 6 is a schematic front view of the disk drive of FIG. 4. FIG. 7 is a schematic exploded sectional view of the disk loading apparatus of FIG. 4.

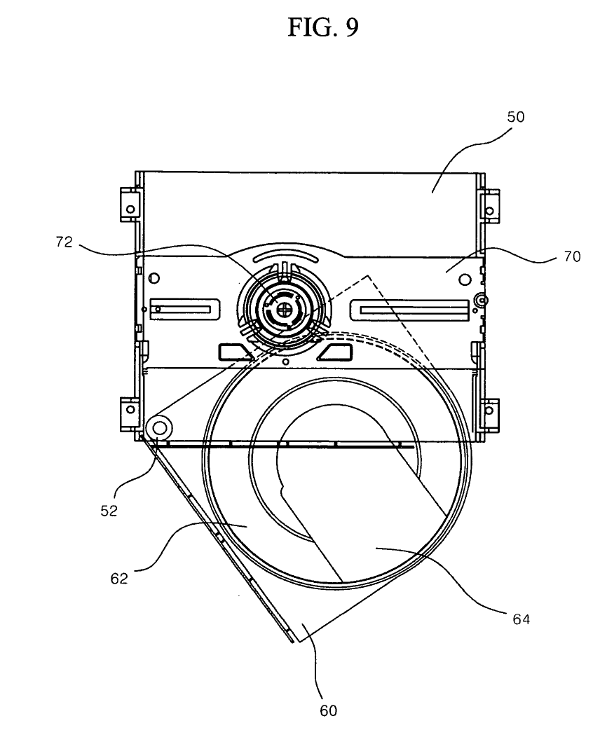

Referring to FIGS. 4-7, a main base or body 50 forms a frame structure of the disk drive. A variety of components of the disk drive are mounted on the main base 50. For example, components are provided for rotating a disk and recording signals onto the disk and/or reproducing the recorded signals from the disk. A boss 52, as shown in FIG. 9, is formed on the main base 50, for example, on one corner at a front side of the main base 50. The boss 52 acts as a center of rotation of a tray 60 described below.

As shown in FIG. 5, components which provide power to load and/or unload the disk are provided at one side of the main base 50. A driving motor 54 is mounted on the main base 50 and a power transmission unit 51 is provided for transmitting power from the driving motor 54 to a tray 60 rotatably mounted on the main base 50. The power transmission unit 51 includes a driving pulley 54′ provided on a rotary shaft of the driving motor 54, a belt 55 wound around the driving pulley 54′ at one end thereof, a pulley gear 56 provided on the main base 50 and around which the belt 55 is also wound, at the other end thereof, a geared portion formed on the pulley gear 56 and engaged with a driving gear 57, and the driving gear 57, which is mounted on the main base 50 and corresponds to the final gear of the power transmission unit 51.

The tray 60 is installed on the main base 50 such that it can be rotated and move inside and outside the main base 50. The tray 60 may be in the shape of a sector, as shown in FIG. 9, of which a central angle is 90 degrees; however, other shapes may also be appropriate. In such a configuration, the center of rotation of the tray is located at a center point of the sector, and a round arc of the sector has a predetermined radius of curvature. Thus, in such a configuration, the tray 60 can be smoothly rotated and move inside and outside of the main base 50 since it has a constant length from its center point to its corresponding arc.

A disk-seating portion 62 is formed on a top surface of the tray 60, and corresponds to the part on which a disk is seated during movement of the tray 60. A pickup window 64 is formed to extend radially from a center of the tray 60 to an inner edge of the disk-seating portion 62. When the tray 60 is positioned within the main base 50, a turntable (not shown) for rotating the disk is placed adjacent the pickup window 64 and light emitted from an optical pickup (not shown) for recording signals onto a signal-recording surface of the disk or reproducing the signals recorded on the disk passes through the pickup window 64.

In the embodiment in which the tray 60 is in the form of a sector, a hole 66 that acts as the center of rotation of the tray when the tray is rotatably mounted on the main base 60 is formed at a center point of the sector. The boss 52 is inserted into the hole 66 so that the tray 60 can be rotated about the boss 52. A screw 68, for example, may be used to rotatably attach the tray 60 to the main base 50. The screw 68 would be screwed into the boss 52 so that the tray 60 cannot be detached from the main base 50.

Further, a rack 69 is formed on a bottom surface of the tray 60 at a location spaced apart by a given radius from the hole 66. The tack 69 is engaged with the driving gear 57 so that the power from the driving motor 54 can be transmitted to the tray 60.

The location at which the center of rotation of the tray 60 is formed will be hereinafter described with reference to FIG. 8. A gap C is provided between the tray 60 and one side of the main base 50, that is, between one side of the tray 60 with its center of rotation provided thereon and a corresponding inner side of the main base 50. The gap C is needed to allow the tray 60 to rotate without interfering with the side of the main base 50. Further, it is preferable that the distance between the center of rotation of the tray 60 and the inner side of the main base 50 is approximately 4C and the distance between the center of rotation of the tray 60 and a front end of the main base 50 is approximately 3C. However, other allowances may be appropriate based on the particular design parameters and application. A clamping bracket 70 and a clamp 72 provided on the clamping bracket 70 are provided to hold the disk onto the turntable.

Hereinafter, the operation of the disk loading apparatus for a disk drive according to the above described embodiment of the invention will be described in detail.

First, how the tray 60 enters the main base 50 and exits therefrom according to the above described embodiment of the invention will be described. The tray 60 is normally accommodated in the main base 50, except during loading or unloading of a disk. In order to load or unload a disk, at least a portion of the tray 60 should be taken out from the main base 50.

That is, when a signal for taking the tray 60 out from the main base 50 is received, the driving motor 54 is operated to transmit power to the power transmission unit 51, including the driving pulley 54′, the belt 55, the pulley gear 56, the driving gear 57 and the rack 69 in this order. With the transmission of power, the tray 60 is rotated in a clockwise direction with respect to FIG. 4.

Such an operation causes the tray 60 to be taken out from the main base 50, as shown in FIG. 9. It is preferable that the tray 60 not be fully taken out from the main base 50, because one side of the main base 50 adjacent to the center of rotation of the tray 60 may interfere with one side of the tray 60 if the tray 60 is fully taken out from the main base 50. Thus, it is preferable that the tray 60 be rotated within a range of about 50 to 60 degrees.

When the tray 60 is taken out from the main base 50 in such a manner, a disk is seated on the disk-seating portion 62 of the tray 60 and the tray 60 is then reinserted into the main base 50. That is, the driving motor 54 is operated in a reverse direction, transmitting power from the driving motor 54 to the tray 60 so that the tray 60 can be rotated in a counterclockwise direction with respect to FIG. 4 and reinserted into the main base 50.

In a state in which the tray 60 is completely inserted into the main base 50 as such, the disk is seated on the turntable and is fixed by means of the clamp 72 so as to be rotated by the turntable (not shown). Then, signals are recorded and reproduced during the rotation of the disk.

Next, a disk loading apparatus for a disk drive according to another embodiment of the invention will be described in detail.

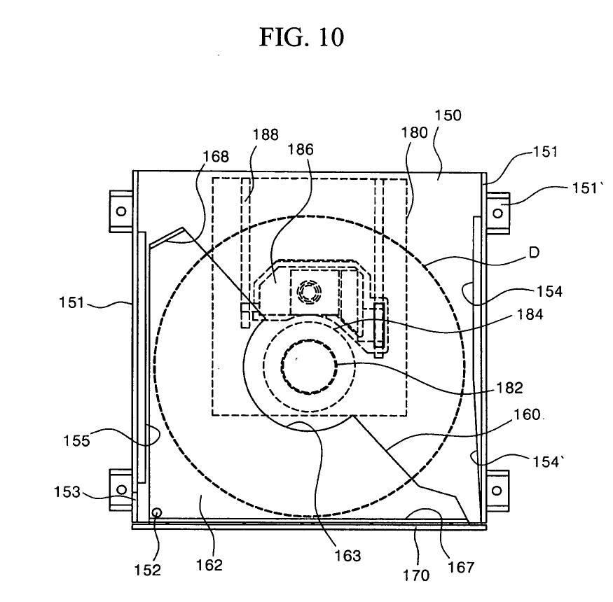

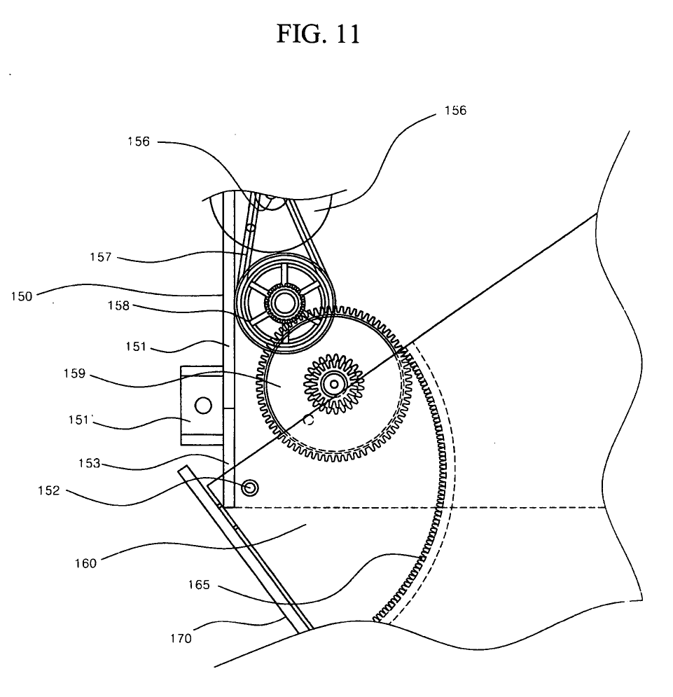

FIG. 10 is a schematic plan view of a disk drive having a disk loading apparatus according to another embodiment of the invention. FIG. 11 is a schematic plan view of a power transmission unit for the disk loading apparatus of FIG. 10.

Referring to FIGS. 10-11, a main base or body 150 forms a frame of the disk drive. A variety of components for the disk drive are mounted on the main base 150. Sidewalls 151 are formed lengthwise in fore and aft directions along both sides of the main base 150, as shown in FIG. 10. A variety of components are mounted in an inner space defined by the sidewalls 151. A plurality of mounting portions 151′, which are required when the disk drive is built into, for example, a stereo set, are formed on outer surfaces of the sidewalls 151. The mounting portions 151′ are not required if the disk drive is installed outside the stereo set, or if it can be attached and detached according to a user's selection.

The components installed on the main base 150 will be briefly described below. As indicated by the dotted lines in FIG. 10, a pickup base 180 is installed on the main base 150. The pickup base 180 is provided with a spindle motor 182 and turntable 184 configured to rotate a disk D. Further, an optical pickup 186 configured to record or reproduce signals on/from the disk is movably supported by guide shafts 188 on the pickup base 180. Of course, the structures associated with the pickup base 180 are not necessarily identical to those in the illustrated embodiment but can be designed in various configurations.

A rotary shaft 152 is formed on the main base 150, for example, at a corner of a front end of the main base 150. The rotary shaft 152 functions as the center of rotation of a tray 160 as described below. An interference prevention portion 153 is formed at a front end of the sidewall 151 on a side on which the rotary shaft 152 is located. The interference prevention portion 153, in the form, for example, of an opening, slot, or indentation formed in the sidewall 151 of the main base 150, is a portion configured to prevent interference with one end of a door 170 upon rotation of the tray 160, as described below.

When the interference prevention portion 153 is properly designed, the rotary shaft 152 can be formed to be positioned maximally close to the sidewall 151. In such a state, it is possible to minimize a gap formed between one end of the tray 160 and the sidewall 151 of the main base 150 in a disk loading position.

First and second side guides 154 and 155 are formed on inner surfaces of both the sidewalls 151 of the main base 150, respectively. The side guides 154 and 155 function to guide the loading and unloading of the disk D and are integrally formed with the sidewalls 151. However, the side guides 154 and 155 are not necessarily formed to protrude as in the illustrated embodiment. The side guides may be formed to be recessed according to design conditions and application. Alternatively, the sidewalls 151 themselves may perform the function of the side guides without having protruding or recessed portions. A predetermined length of the first side guide 154 at a front end thereof, that is, the front end of the main base 150, is formed as a slant portion 154′. The slant portion 154′ guides the disk D more smoothly during the process of loading the disk D.

As shown in FIG. 11, a power transmission unit configured to provide power for rotating the tray 160 upon loading and unloading of the disk D is provided at a side of the main base 150. The power transmission unit 150A includes a driving motor 156 installed on the main base 150, a driving pulley 156′ provided on a rotary shaft of the driving motor 156, a belt 157 wound around the driving pulley 156′ at one end thereof, a pulley gear 158 provided on the main base 150 and around which the belt 157 is wound at the other end thereof, a geared portion 158′ formed on the pulley gear 158 and engaged with a driving gear 159 installed on the main base 150.

The tray 160 is installed on the main base 150 so as to be rotatable about the rotary shaft 152 so as to move inside and outside the main base 150. In the embodiment of FIG. 10, the tray 160 is in the shape of a triangle of which an apex on the side of the center of rotation is a vertical angle. However, the tray 160 does not necessarily take the shape of a triangle. Rather, it is sufficient to design the tray so that upon rotation of the tray, a portion of the tray farthest from the center of rotation does not interfere with the sidewall 151 opposite to the rotary shaft 152.

A disk-seating surface 162 is formed on a top surface of the tray 160. The disk-seating surface 162 is a portion on which the disk D is seated during rotation of the tray 160 and in a loaded position of the disk D. The disk-seating surface 162 is formed with a turntable window 163 at a position corresponding to the turntable 184 at a loaded position of the disk D. In this embodiment, the turntable window 163 is in the form of a semicircular cutout provided in the tray 160. However, other shapes may also be appropriate based on application and design conditions. However, for this embodiment it is not necessary to provide a full pickup window to allow light emitted from the optical pickup 186 to be transferred to a signal-recording surface of the disk D, but rather a semicircular cutout is sufficient. In any case, if a moving path of the optical pickup 186 is designed so as to be blocked by the tray 160 at any point, a pickup window should be formed.

A rack 165 is formed on a bottom surface of the tray 160. In this embodiment, the rack 165 has a radius of curvature centered on the rotary shaft 152. The rack 165 is engaged with a driving gear 159, which transmits power from the driving motor 156 to the tray 160 via the power transmission unit 150A.

A leading end guide 167 is formed on the disk-seating surface 162 of the tray 160, as shown in FIG. 10. The leading end guide 167 is formed to protrude from the disk-seating surface 162 having a thickness at least as large as a thickness of the disk D. The leading end guide 167 functions to guide the disk D during loading and unloading of the disk D. The leading end guide 167 is formed to extend lengthwise along a leading end of the tray 160, as shown in FIG. 10.

A trailing end guide 168 is formed at a trailing end of the tray 160, as shown in FIG. 10. The trailing end guide 168 is also formed to protrude from the disk-seating surface 162 having a thickness at least as large as a thickness of the disk D. The trailing end guide 168 functions to guide the disk D during loading and unloading of the disk D. The trailing end guide 168 is formed to extend at a predetermined angle with respect to a side 168a of the tray 160. Further, the trailing end guide 168 is formed such that an imaginary extension of the trailing end guide 168 intersects an imaginary extension of the leading end guide 167 at a predetermined angle.

Reference numeral 170 designates a door which may be provided as a portion of a front face of the disk drive. The door 170 is provided at the leading end of the tray 160.

Hereinafter, the operation of a disk loading apparatus for a disk drive according to the above-described embodiment of the invention will be described in detail.

How the tray 160 enters the main base 150 and exits therefrom according to the above-described embodiment of the invention will first be described. The tray 160 is normally accommodated in the main base 150 except during loading and unloading of a disk D. To load or unload a disk D at least a portion of the tray 160 should be taken out from the main base 150.

That is, when a signal for taking the tray 160 out from the main base 150 is received, the driving motor 156 is operated to transmit power to the power transmission unit 150A, including the driving pulley 156′, the belt 157, the pulley gear 158, the driving gear 159, and the rack 165 in this order. With the transmission of power, the tray 160 is rotated in a clockwise direction with respect to FIG. 10.

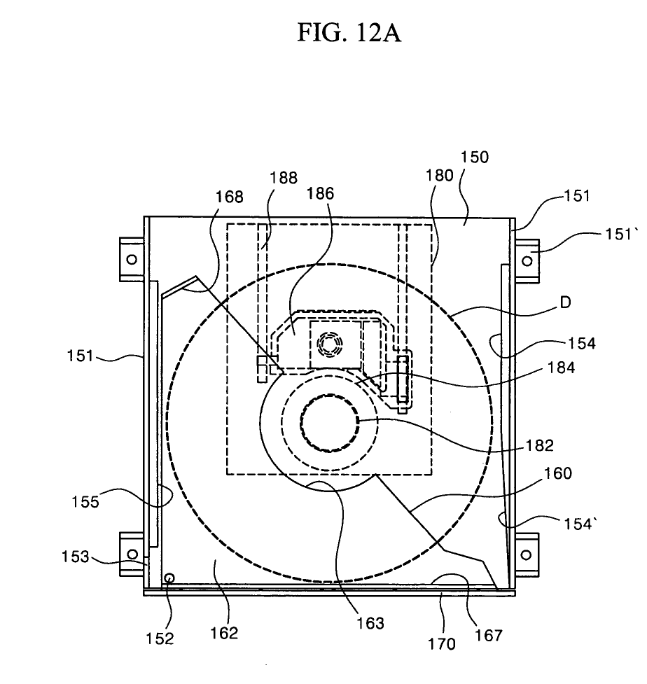

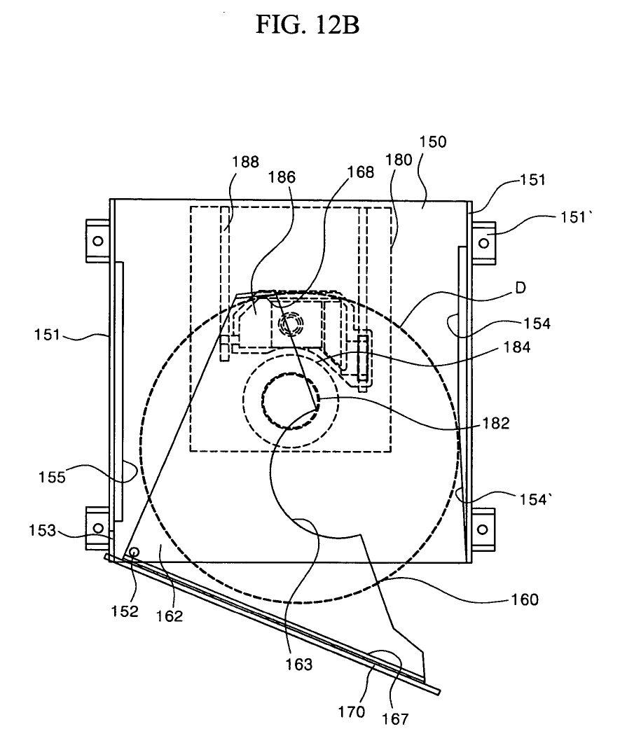

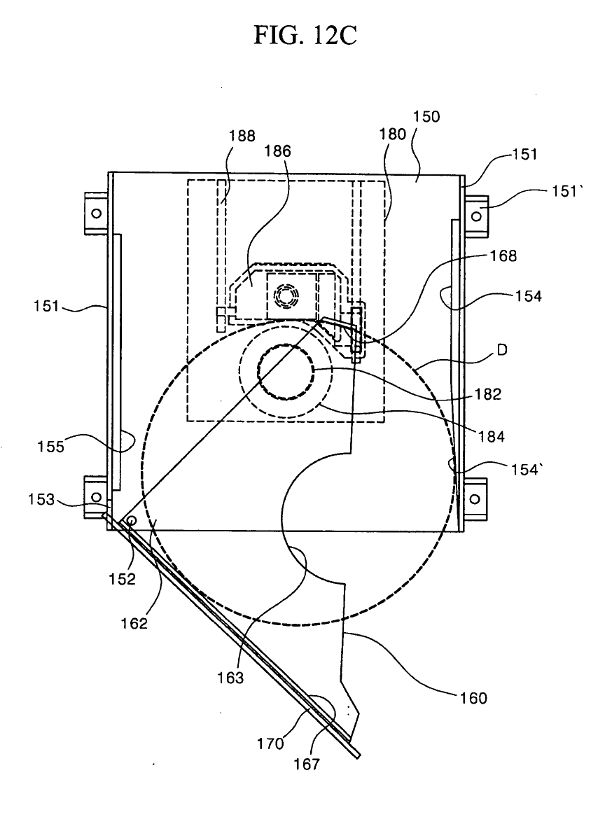

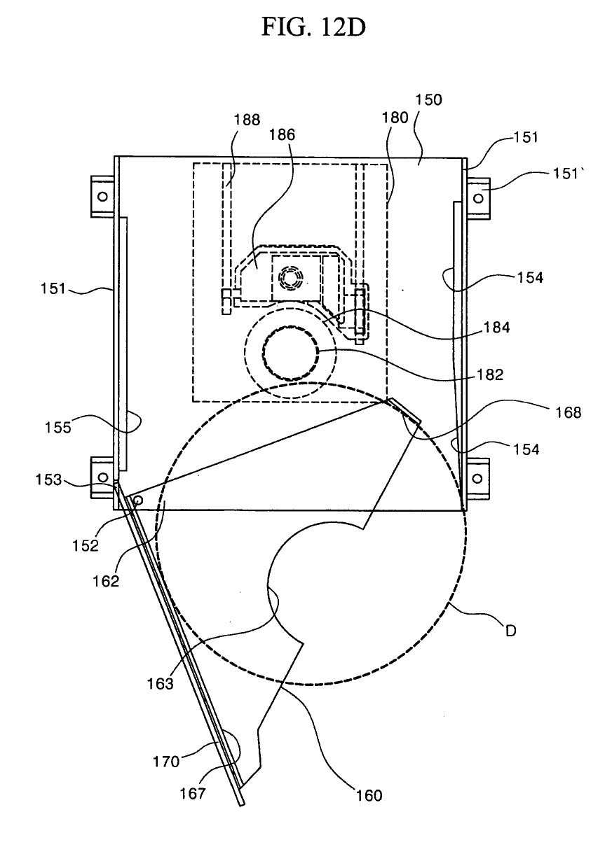

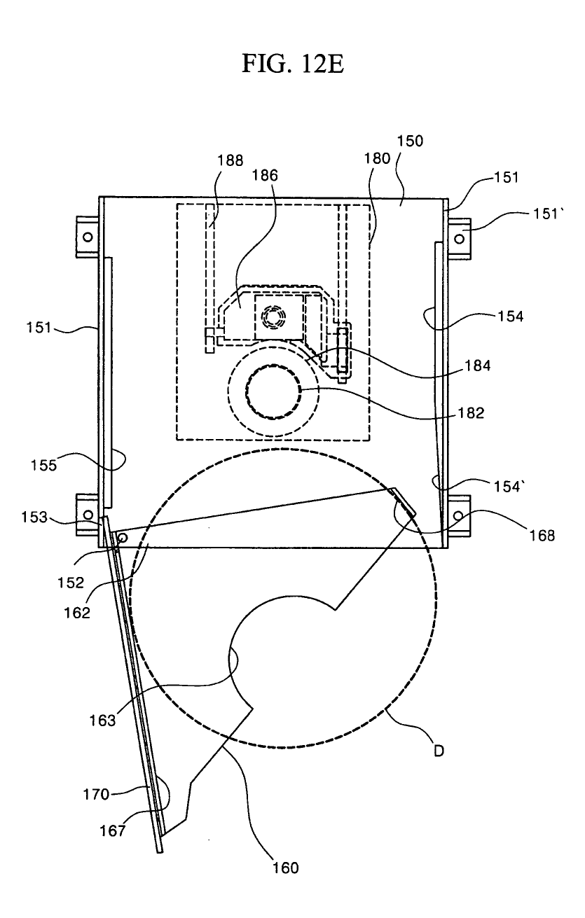

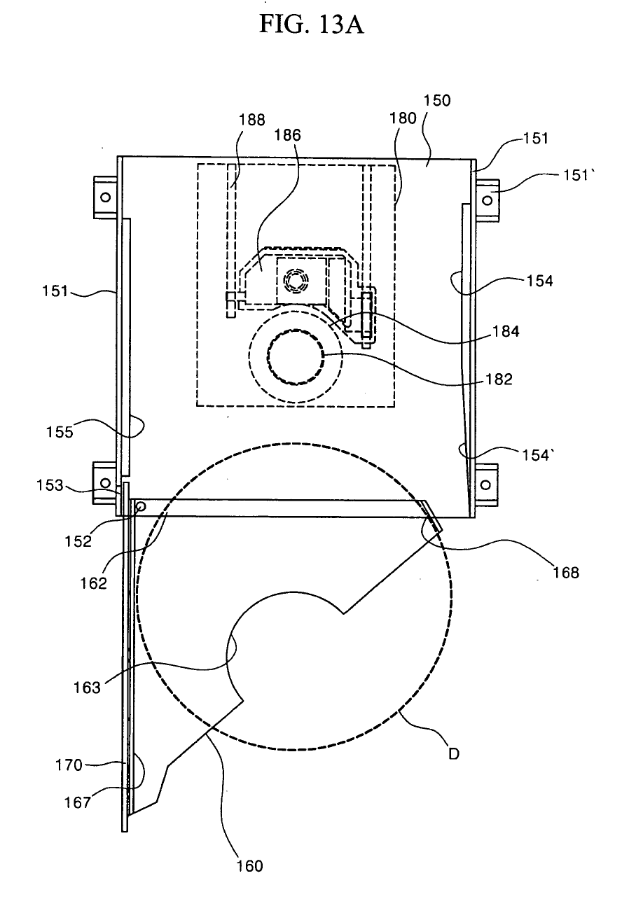

Such an operation causes the tray 160 to unload the disk D as sequentially shown in FIGS. 12A to 12E. First, as the tray 160 is rotated from the state shown in FIG. 12A, a side of the disk D comes into contact with the first side guide 154. As shown in FIG. 12B, when the side of the disk D comes into contact with the first side guide 154, the disk D is pushed rearward on the tray 160 until the disk D is caught by the trailing end guide 168, as shown in FIG. 12C.

As the tray 160 is further rotated as shown in FIG. 12C, the disk D moves together with the tray 160 while being guided by the trailing end guide 168, the first side guide 154, and the leading end guide 167. When the disk D moves outside the main base 150 due to the rotation of the tray 160, it is no longer guided by the first side guide 154 and is then guided only by the leading end guide 167 and the trailing end guide 168, as shown in FIG. 12D.

Finally, the tray 160 completely exits from the main base 150 as shown in FIG. 12E. In such a state, a user can remove the disk D from the tray 160 and/or exchange it with another disk D.

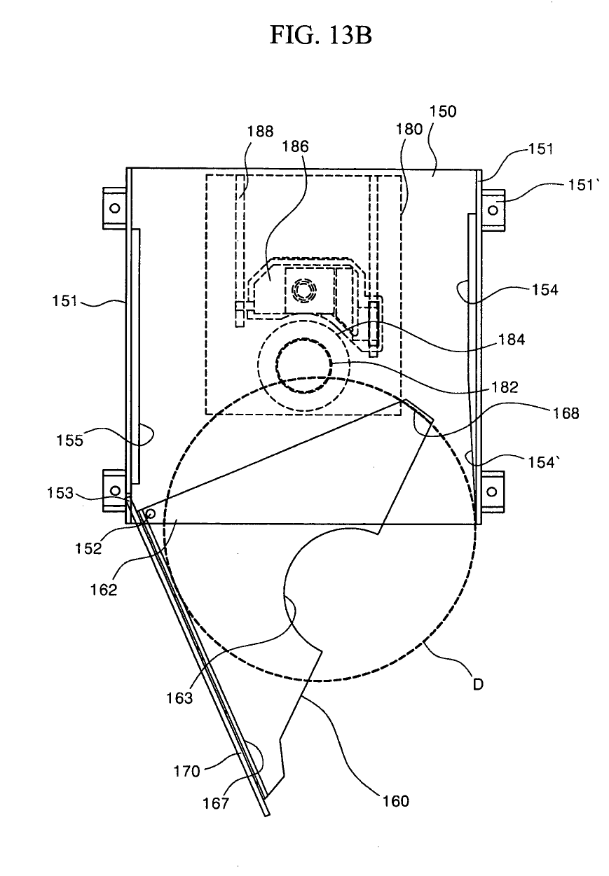

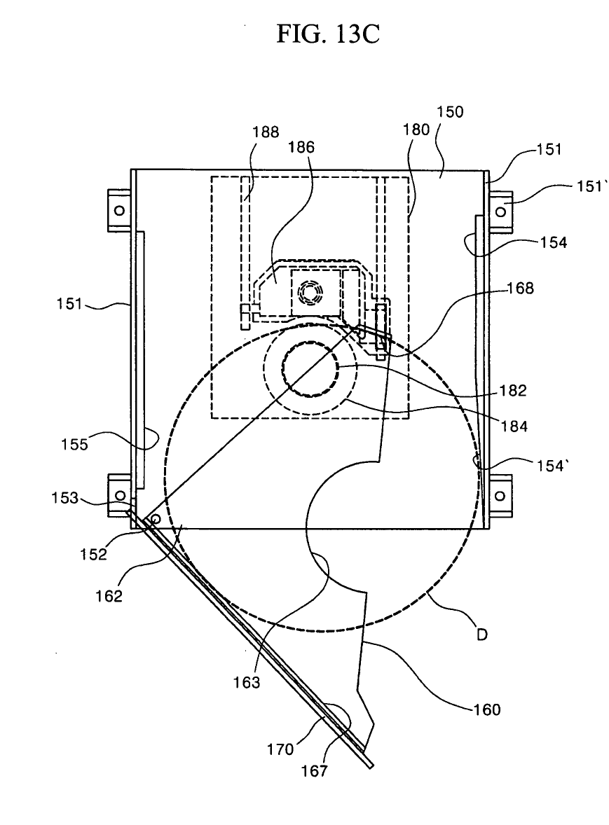

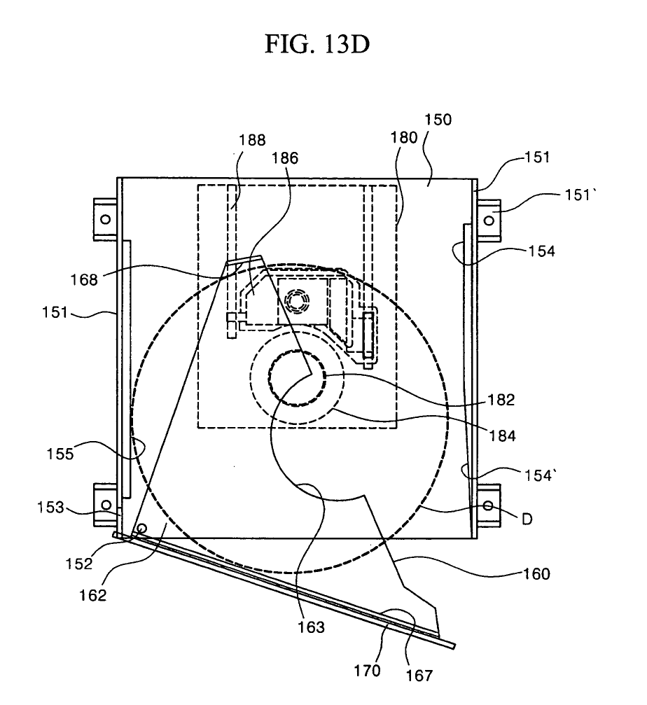

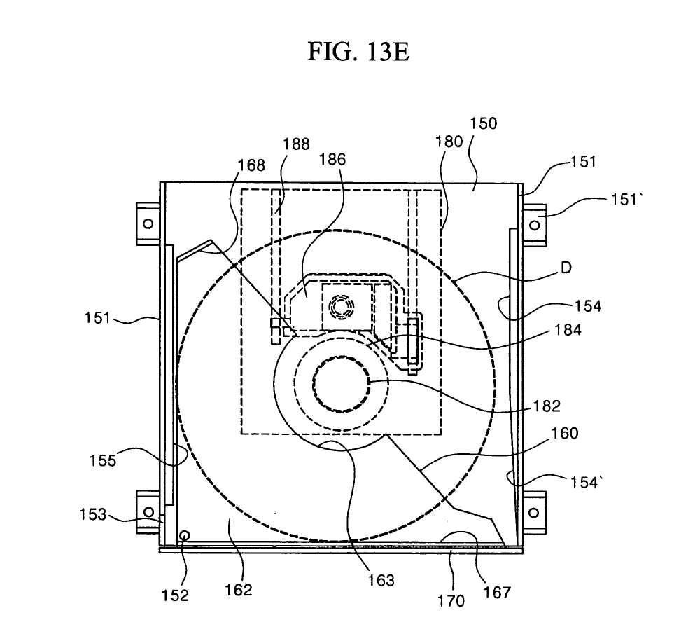

Next, the operation for loading a disk D onto the tray 160 will be described with reference to FIGS. 13A to 13E.

A disk D is loaded, or an already loaded disk is exchanged with another disk D in a state in which the tray 160 is positioned outside the main base 150. At this time, the disk D sits on the disk-seating surface 162 of the tray 160 such that it is simultaneously in contact with the leading end guide 167 and the trailing end guide 168, as shown in FIG. 13A.

If a signal for loading the disk D is received, the tray 160 is rotated and moved into the main base 150, as shown in FIG. 13B. When the tray 160 has been rotated a certain amount, a side of the disk D comes into contact with a front end of the slant portion 154′ of the first side guide 154 and begins to be guided thereby. At this time, the disk D is guided but is not caught by the slant portion 154′.

FIG. 13C shows the last moment at which the disk D is in contact with the first side guide 154. Therefore, the disk D is no longer guided by the first side guide 154 during the subsequent loading operation of the disk D.

As the tray 160 is further rotated, the disk D comes into contact with and begins to be guided by the second side guide 155, as shown in FIG. 13D. From this point on, the disk D is no longer in contact with the trailing end guide 168, and is then guided by the second side guide 155 and the leading end guide 167.

When the tray 160 finally reaches the loading position, the disk D is in contact with the second side guide 155 and the leading end guide 167, as shown in FIG. 13E. In such a state, the disk D is seated on the turntable 184 and then clamped by a clamp (not shown). Thus, the loading of the disk D is completed.

Next, a disk loading apparatus for a disk drive according to still another embodiment of the invention will be described in detail.

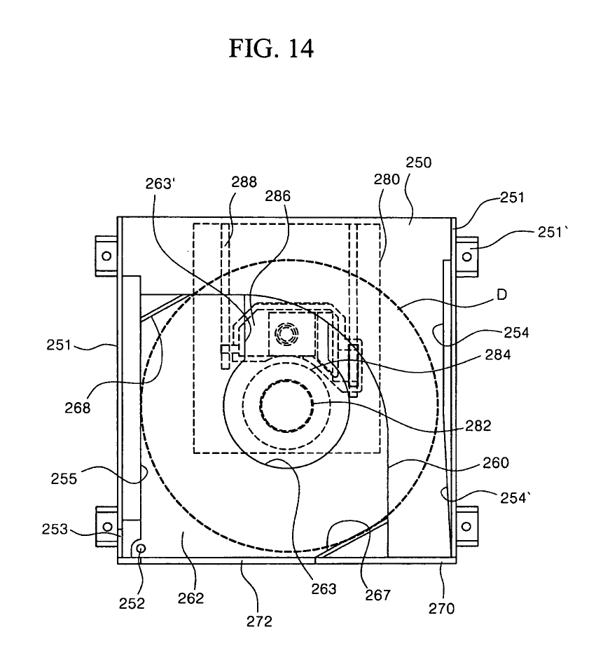

Referring to FIG. 14, in this embodiment, first and second guides 254 and 255 are formed along inner surfaces of sidewalls 251 of a main base 250. It is preferable that the distance between the side guides 254 and 255 be substantially identical with a diameter of the disk D. However, it is more preferable that the second side guide 255 protrude larger than in the second embodiment, as shown in FIG. 14, in order to prevent the disk D from interfering with a rotary shaft 252.

Further, the tray 260 is formed with a leading end guide 267 and a trailing end guide 268. The leading end guide 267 and the trailing end guide 268 are formed parallel to each other at a leading end and a trailing end of the tray 260, respectively.

In this embodiment, a distance between the leading end guide 267 and the trailing end guide 268 is set to be slightly larger than a diameter of the disk D. In practice, the leading end guide 267 and the trailing end guide 268 extend parallel to one another in a tangential direction at outer edges of the disk D.

A pickup window 263′ is formed in the tray 260, in this embodiment, such that a first edge of the pickup window 263′, which intersects a line passing through the rotary shaft 252 and a center of a turntable window 263, is longer than a second opposite edge of the pickup window 263′, as shown in FIG. 14. In practice, when the tray 260 is rotated, the second edge is adjacent to a front end of a slant portion 254′ formed in the sidewall 254 of the main base 250.

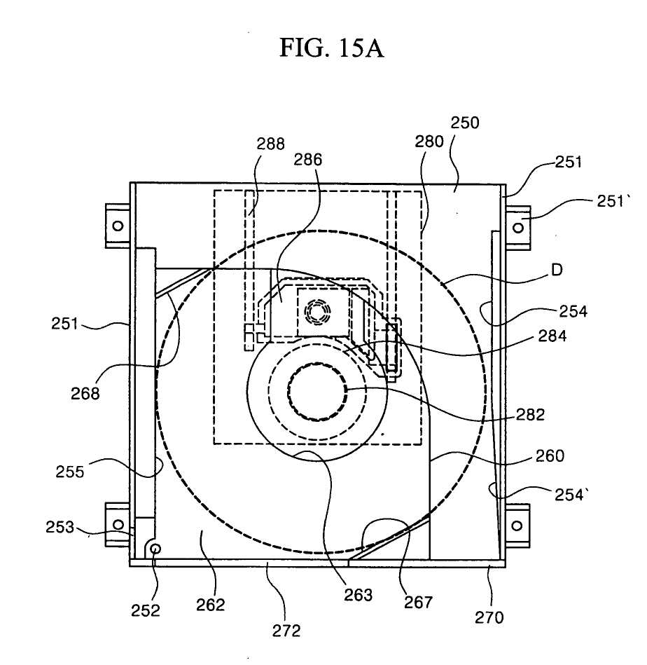

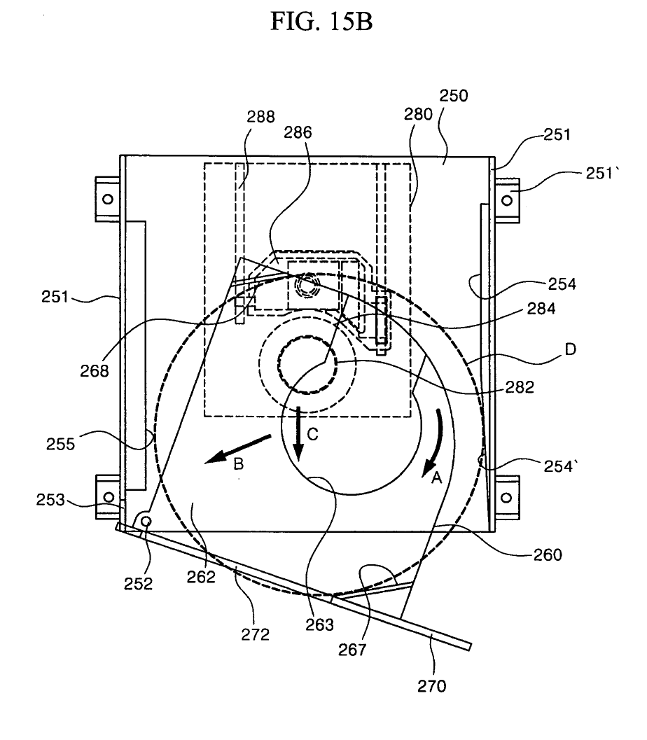

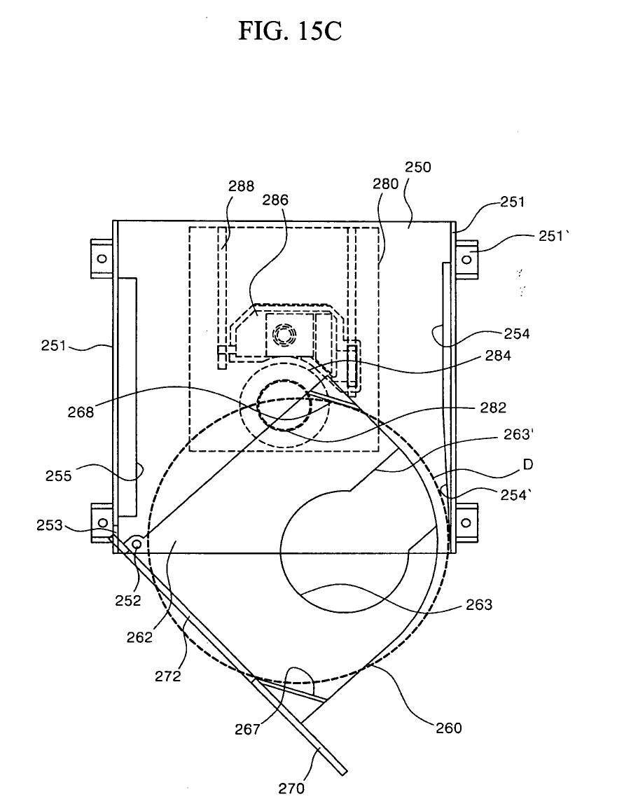

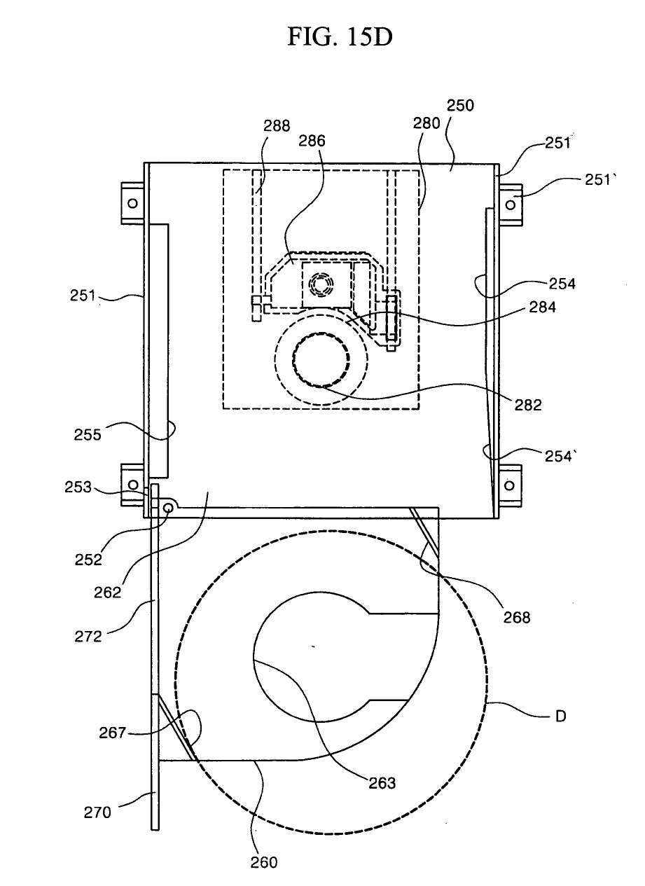

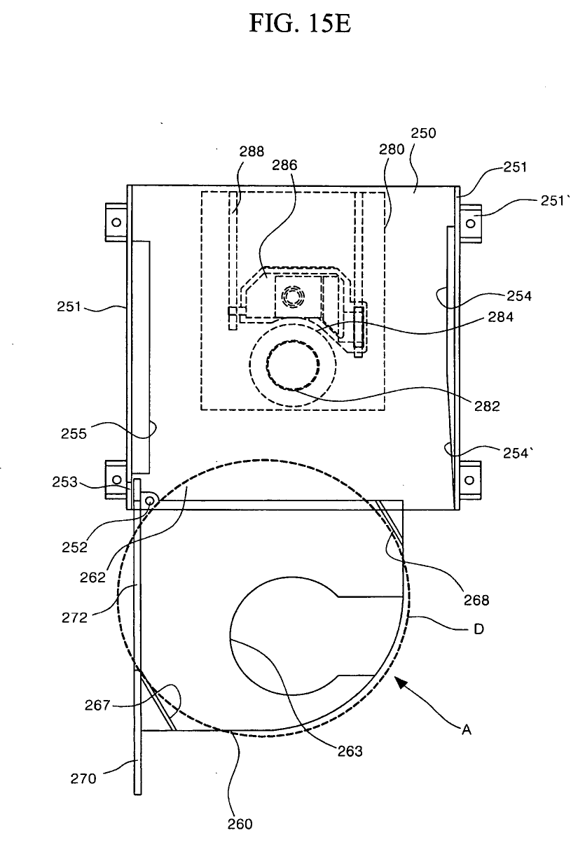

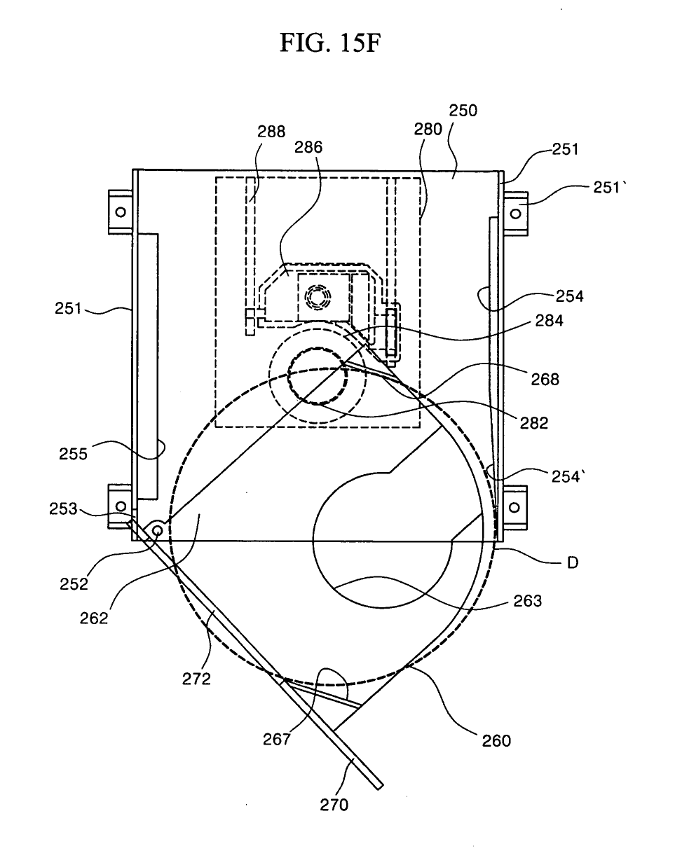

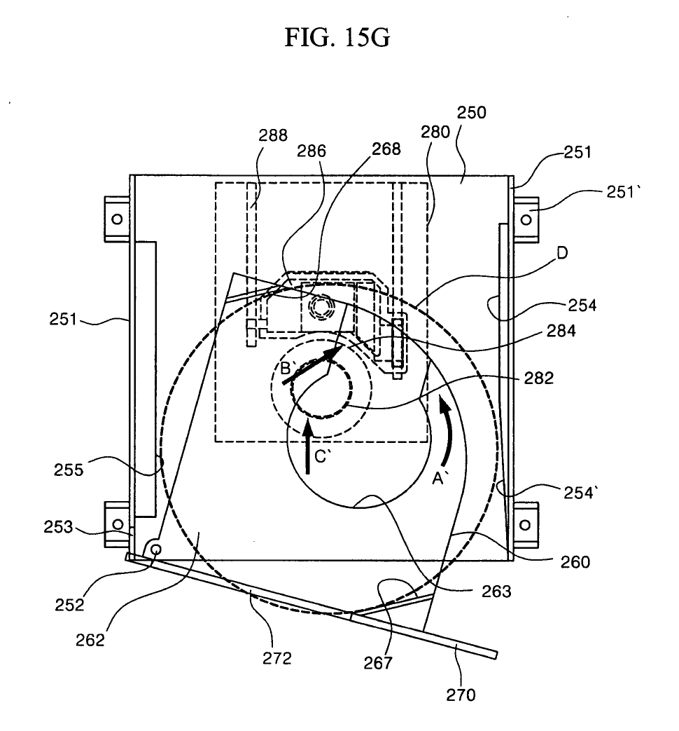

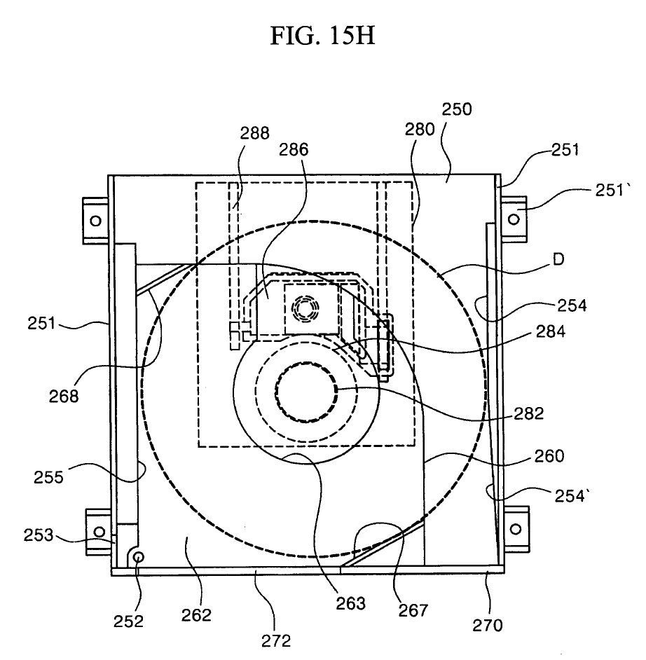

In this embodiment, the disk D can protrude outside the tray 260 upon loading and unloading thereof That is, a side of the disk D may pass through a guide slot 272 formed in the door 270 at a leading end of the tray 260 and protrudes outside the tray 260, as shown in FIG. 15B. In such a case, the disk-seating surface 262 should be formed to be flat without any projections except the guides 267 and 268.

The operation of the disk loading apparatus according to the above described embodiment of the invention will be described with reference to FIGS. 15A to 15H.

FIG. 15A shows a disk D which has been completely loaded, and which is seated on the turntable 284, that is, the disk D is spaced slightly from the disk-seating surface 262 of the tray 260. At this time, the first and second side guides 254 and 255 and the leading and trailing end guides 267 and 268 are adjacent to the circumference of the disk D.

If an unloading signal is received in such a state, the turntable 284 is lowered and the disk D is seated on the tray 260. Then, the tray 260 is rotated about the rotary shaft 252 and begins to exit from the main base 250.

As shown in FIG. 15B, the disk D begins to protrude from the tray 260 while being guided by the guides 254, 255, 267, and 268. That is, as the tray 260 is rotated in a direction indicated by an arrow A in FIG. 15B, the disk D moves in a direction indicated by an arrow B with respect to the tray 260 and in a direction indicated by an arrow C with respect to the main base 250. Accordingly, the disk D begins to protrude from the tray 260.

As the tray 260 is further rotated, the disk D is no longer guided by the second side guide 255 as shown in FIG. 15C. In this state, the disk D is adjacent to the rotary shaft 252.

Then, when the tray 260 exits from the main base 250 to a certain extent, as shown in FIG. 15D, the disk D is no longer guided even by the first side guide 254. When the tray 260 completely exits from the main base 250, the disk D is guided by the leading and trailing guides 268 and 270 and the slot of the door 270, as shown in FIG. 15D.

Meanwhile, in the case of exchanging of an already loaded disk with a new disk D, to load the new disk D, the disk D is seated on the tray 260, preferably maximally close to the rotary shaft 252 of the tray 260. That is, the disk D is seated on the tray 260 in a direction indicated by an arrow A in FIG. 15E.

If an operational signal for loading the disk D is received, the tray 260 is rotated in a counterclockwise direction with respect to FIG. 15E. As the tray 260 is rotated, the disk D comes into contact with and begins to be guided by the slant portion 254′ of the first side guide 254, as shown in FIG. 15F. In such a state, the disk D is guided by the leading end guide 267, the trailing end guide 268, and the first side guide 254.

As the tray 260 is further rotated, the disk D begins to be guided by the second side guide 255, as shown in FIG. 15G. At this time, the tray 260 is rotated in a direction indicated by an arrow A′ in FIG. 15G and the disk D moves in a direction indicated by an arrow B′ with respect to the tray 260, and also in a direction indicated by an arrow C′ with respect to the main base 250.

Meanwhile, FIG. 15H shows a state in which the disk D has been completely loaded. When the disk D has been completely loaded in such a way, the disk D is fixed to the turntable 284 by means of a clamp (not shown).

The invention provides at least the advantages listed below.

The invention provides a novel concept disk loading apparatus for a disk drive, which is light, thin, short, and small in comparison to prior art devices.

Further, the tray is rotated about a corner of the main base to load and unload a disk. Therefore, the size of the tray is minimized, thereby reducing material costs and lowering production costs. Furthermore, the size of the disk drive as a whole is also reduced since the size of the tray is minimized.

Additionally, the invention provides a disk loading apparatus for a disk drive capable of quickly loading and unloading a disk. That is, since the tray moves inside and outside a set while being rotated with respect to the main base, loading and unloading operations of the disk can be relatively quickly performed.

Finally, the value of products can be improved since a disk drive can be constructed by means of a novel disk-loading method by which the disk is loaded and unloaded while the tray is rotated about the corner of the main base.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A disk loading apparatus for a disk drive, comprising:
a main body; and
a tray including a disk-seating portion configured to be rotated inside and outside the main body about a center of rotation located at one side of the main body.

2. The disk loading apparatus as claimed in claim 1, further comprising a drive unit configured to rotate the tray.

3. The disk loading apparatus as claimed in claim 2, wherein the drive unit comprises:
a driving motor configured to be mounted on a main base and rotate in a forward or reverse direction; and
a power transmission unit configured to transmit driving force from the driving motor to the tray.

4. The disk loading apparatus as claimed in claim 3, wherein the power transmission unit comprises at least one gear.

5. The disk loading apparatus as claimed in claim 4, further comprising a rack gear having a predetermined radius of curvature formed on a bottom surface of the tray and configured to engage with the driving gear of the power transmission unit.

6. The disk loading apparatus as claimed in claim 1, wherein the center of rotation of the tray is located at a front end of the main body.

7. The disk loading apparatus as claimed in claim 6, wherein the tray is in the form of a sector of which a center point acts as the center of rotation of the tray.

8. The disk loading apparatus as claimed in claim 1, wherein a predetermined gap is formed between the tray and the main body on a side of the tray on which the center of rotation is located.

9. The disk loading apparatus as claimed in claim 1, further comprising:
a disk guide unit provided on the tray and the main body and configured to cause a disk to be loaded and unloaded according to a rotating motion of the tray.

10. The disk loading apparatus as claimed in claim 9, wherein the center of rotation of the tray is located at a front end of the main body.

11. The disk loading apparatus as claimed in claim 9, wherein the disk guide unit comprises:
a leading end guide formed to extend along a leading end of the tray;
a trailing end guide formed to extend at a predetermined angle with respect to a side edge of the tray; and
first and second side guides formed on both sides of the main body.

12. The disk loading apparatus as claimed in claim 11, wherein the first side guide comprises a slant portion configured to facilitate entrance of the disk into the disk drive formed at a front end thereof.

13. The disk loading apparatus as claimed in claim 10, further comprising an interference prevention portion configured to prevent interference of the leading end of the tray with and provided at the front end of the main body adjacent the center of rotation of the tray.

14. The disk loading apparatus as claimed in claim 9, wherein the disk guide unit comprises:
leading and trailing end guides formed to face each other at leading and trailing ends of the tray, respectively;
first and second side guides formed on both sides of the main body; and
a guide slot formed in a door provided at the leading end of the tray and configured to allow the disk to protrude outside the tray.

15. The disk loading apparatus as claimed in claim 14, wherein the first side guide comprises a slant portion configured to facilitate entrance of the disk into the disk drive formed at a front end thereof.

16. The disk loading apparatus as claimed in claim 14, wherein the disk-seating portion is formed such that all portions except the guides are flat up to edges of the tray.

17. The disk loading apparatus as claimed in claim 14, wherein the second side guide is configured to protrude from one side of the main body toward the first side guide by a predetermined distance.

18. A disk drive comprising the disk loading apparatus of claim 1.

19. A disk loading apparatus for a disk drive, comprising:
a main body; and
a tray rotatably coupled to a shaft formed on a corner of the main body so that the tray is horizontally rotatable about the shaft in a plane parallel to a top surface of the main body.

20. The disk loading apparatus as claimed in claim 19, further comprising a drive unit configured to rotate the tray.

21. The disk loading apparatus as claimed in claim 20, wherein the drive unit comprises:
a driving source provided on one side of the main body; and
a power transmission unit configured to transmit power from the driving source to rotate the tray.

22. The disk loading apparatus as claimed in claim 21, further comprising a rack having a predetermined radius of curvature formed on a bottom surface of the tray and engaged with a driving gear of the power transmission unit.

23. The disk loading apparatus as claimed in claim 19, wherein the shaft is formed on a front corner of the main body.

24. The disk loading apparatus as claimed in claim 19, wherein the tray includes a disk-seating portion formed in a bottom surface thereof.

25. The disk loading apparatus as claimed in claim 19, wherein the tray is in the shape of a sector.

26. The disk loading apparatus as claimed in claim 19, wherein the tray comprises:
a leading end guide formed to extend along a leading end of the tray; and
a trailing end guide formed to extend at a predetermined angle with respect to a side edge of the tray.

27. The disk loading apparatus as claimed in claim 26, wherein the main body includes first and second side guides formed at both inner sides thereof to extend from a front end to a rear end of the main body.

28. A disk drive comprising the disk loading apparatus of claim 19.
